(19) United States
(12) Patent Application Publication
(10) Pub. No.: US 2014/0189807 A1
(43) Pub. Date: Jul. 3, 2014

(54) METHODS, SYSTEMS AND APPARATUS TO FACILITATE CLIENT-BASED AUTHENTICATION

(71) Applicants: Conor P. Cahill, Waterford, VA (US); Vinay Phegade, Beaverton, OR (US); Jason Martin, Beaverton, OR (US); Anand Rajan, Beaverton, OR (US); Nikhil M. Deshpande, Beaverton, OR (US); Radia Perlman, Redmond, WA (US)

(72) Inventors: Conor P. Cahill, Waterford, VA (US); Vinay Phegade, Beaverton, OR (US); Jason Martin, Beaverton, OR (US); Anand Rajan, Beaverton, OR (US); Nikhil M. Deshpande, Beaverton, OR (US); Radia Perlman, Redmond, WA (US)

(21) Appl. No.: 13/822,216

(22) PCT Filed: Nov. 18, 2011
(86) PCT No.: PCT/US11/61359

§ 371 Date: Mar. 11, 2013

Related U.S. Application Data
(60) Provisional application No. 61/548,570, filed on Oct. 18, 2011.

(51) Int. Cl. H04L 29/06

(52) U.S. Cl. CPC H04L 63/08
USPC 726/4

(57) ABSTRACT

Methods, systems and apparatus are disclosed to facilitate client-based authentication. An example method includes associating an identity authority with a client platform in an isolated execution environment, associating a user identity with the identity authority, generating a first key pair associated with a first service provider, generating an attestation based on a first authorization sequence of the client platform, and signing the attestation with a portion of the key pair and sending the signed attestation to the first service provider to authorize communication between the client platform and the first service provider.

### CROSS REFERENCE TO RELATED APPLICATIONS

This application claims the benefit of U.S. Provisional Patent Application Ser. No. 61/548,570, filed Oct. 18, 2011, which is hereby incorporated herein by reference in its entirety.

### FIELD OF THE DISCLOSURE

This disclosure relates generally to network security, and, more particularly, to methods, systems and apparatus to facilitate client-based authentication.

### BACKGROUND

In recent years, a number of identity storage instances for users of on-line services has increased. Each user may interact with multiple on-line service providers (e.g., a bank web site, a library web site, a streaming movie portal, social networking portal(s), web-based email services, etc.), in which each service provider typically requires at least one form of authentication. Example forms of authentication include usernames and corresponding passwords, which are typically managed and stored by a corresponding service provider. The usernames and passwords are intended to allow the service provider to verify that a visitor corresponds to an identity, such as an identity associated with an account (e.g., a bank account, a library account, a movie streaming account, a social network portal account, a web-based e-mail account, etc.).

In many circumstances, users find managing multiple different username and/or password combinations to be tedious and/or cumbersome. As a result, many users apply the same username and/or password with each of the multiple on-line service providers. Further, the selected username and password credentials selected and/or otherwise generated by the users are typically weak and/or susceptible to, for example, dictionary-based attack.

### BRIEF DESCRIPTION OF THE DRAWINGS

FIG. 1 is a schematic illustration of an example client-based authentication system controlled in accordance with the teachings of this disclosure to facilitate client-based authentication.

FIG. 2 is a schematic illustration of an example implementation of the example trusted identity manager of FIG. 1 to facilitate client-based authentication.

FIGS. 3, 4A, 4B, 5 and 6 are flowcharts representative of example machine readable instructions that may be executed to implement the example client-based authentication system of FIG. 1 and/or the trusted identity manager of FIGS. 1 and/or 2.

FIG. 7 illustrates an example processor platform that may execute the instructions of FIGS. 3, 4A, 4B, 5 and/or 6 to implement any or all of the example methods, systems, and/or apparatus disclosed herein.

### DETAILED DESCRIPTION

Methods, systems, apparatus, and articles of manufacture are disclosed, which include associating an identity authority with a client platform in an isolated execution environment, associating a user identity with the identity authority, generating a first key pair associated with a first service provider, generating an attestation based on a first authorization sequence of the client platform, and signing the attestation with a portion of the key pair and sending the signed attestation to the first service provider to authorize communication between the client platform and the first service provider.

Employing a unique username and password combination with each service provider minimizes an amount/degree of damage caused by a hacker when one of the service providers' systems is compromised. For example, a hacked service provider system may store usernames and passwords as cleartext and, in the event a user employs the same username/password combination at one or more other sites, place the security of the user at those other services at further risk of attack. Additionally, even if a user employs multiple different combinations of usernames and corresponding passwords, such usernames and passwords may be relatively easy for an attacker/hacker to guess based on readily available information pertaining to the user (e.g., a first name, a middle initial, a last name, a phone number, etc.). In other words, secure random passwords are rarely created by users despite service provider rules and/or recommendations. Furthermore, a user that employs multiple different combinations of usernames and corresponding passwords may find that memorizing such combinations is tedious and/or impractical. In such instances, the user may rely on one or more “cheat-sheets” that, if lost or stolen, place the user at great risk for identity theft, bank theft, impersonation, etc.

In most circumstances, authentication occurs at the beginning of a session between the user and the service provider. In the event an authenticated session does not receive one or more inputs during a threshold period of time, the service provider may automatically terminate the session due to inactivity. Automatic timeouts attempt to protect the user that accidentally forgets to log-off of an active session, thereby preventing others from viewing and/or otherwise interacting with an account of the user. While relatively short timeout time periods may minimize the risk of others interacting with the user's account, such short timeout time periods may be particularly frustrating to the user in the event they are still present at the machine (e.g., PC, laptop, tablet, phone, etc.) being used. Moreover, such relatively short timeout time periods still fail to protect users that physically walk away from a machine on which the user is logged onto the service provider site(s).

Methods, apparatus, systems and/or articles of manufacture disclosed herein extend an identity manager from trusted client hardware to facilitate, in part, local authentication of a client user, presence detection and continuous passive re-authentication of the client user. Additionally, methods, apparatus, systems and/or articles of manufacture disclosed herein facilitate active session protection in the event the client user steps away, thereby eliminating reliance upon predetermined and/or arbitrary timeout periods managed by a, for example, service provider.

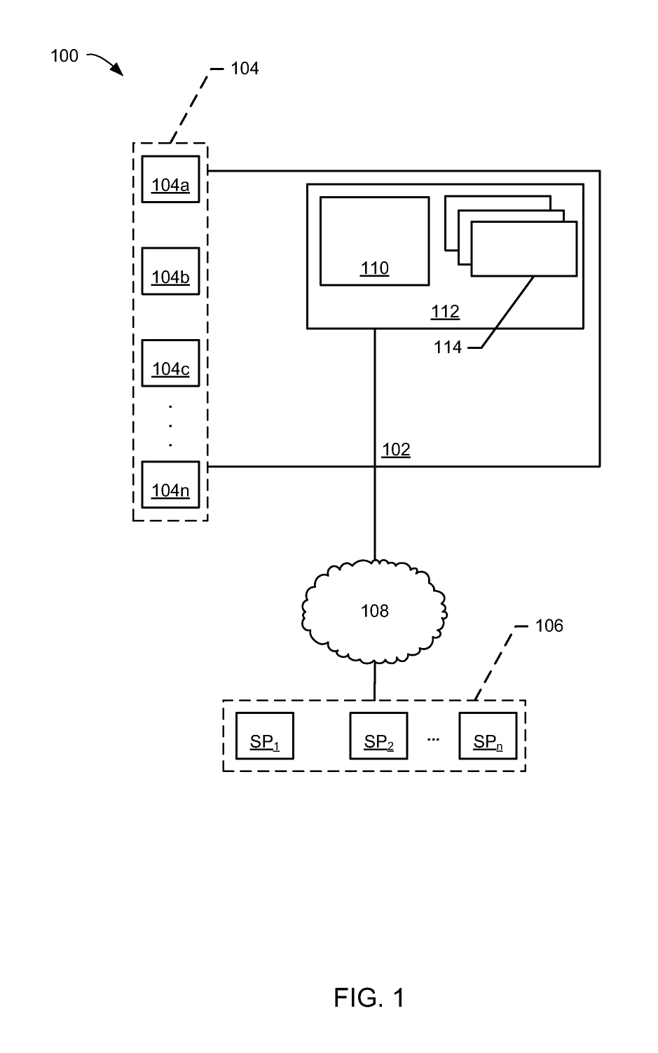

In the illustrated example of FIG. 1, an example client-based authentication (CBA) system 100 includes a client platform 102 communicatively coupled to an authentication appliance pool 104 containing any number of authentication appliances 104a-n, and service providers 106 via one or more networks 108. The example client platform 102 may include any type of client computing device including, but not limited to, a personal computer (PC) (e.g., a desktop, a laptop, a netbook, etc.), a server/workstation, a personal digital assistant (PDA), a telephone (e.g., a smartphone) and/or a tablet computing device (e.g., an iPad®, an Android® tablet, etc.). The example authentication appliance pool 104 may include any number of authentication appliances 104a-n and may operate as built-in components of the example client platform 102 and/or may be communicatively coupled to the example client platform 102 via one or more communication paths including, but not limited to, universal serial bus (USB), FireWire (IEEE 1394), parallel port(s), serial port(s) (e.g., RS-232), general purpose interface bus (GPIB—IEEE-488), Bluetooth, local area network connection(s) and/or Wi-Fi (IEEE 802.11x), etc. Example authentication appliances 104a-n may include, but are not limited to, fingerprint reading device(s), camera(s) (e.g., webcam), smartcard reader(s), keyboard(s), motion sensor(s) and/or biological sensing device(s).

Users of computing platforms typically perform one or more operations by connecting to service providers over a network, such as the Internet. Traditionally, the service provider(s) 106 manage one or more authentication services and/or procedures by way of username and corresponding password authentication, which is relatively inexpensive to deploy and maintain. However, such service-provider-managed authentication procedures allow adversaries to steal and/or otherwise compromise user credentials, particularly when users become desensitized to utilizing the same and/or similar username and password combinations across a number of different service providers. In the event one service provider is attacked, the username and password combination may be used by the attacker to obtain access to other service providers, such as bank websites/portals and/or e-mail websites/portals. Additionally, even if the user were to employ a different username and password combination to serve as credential access to the service provider, the service provider may still have no indication that the entity asserting the credentials is legitimately associated with a corresponding service provider account. In other words, the accessing entity may be the adversary that stole the username and password combination.

To reduce and/or even eliminate instances of credential misuse when accessing one or more of the service providers 106, the example client platform 102 of FIG. 1 includes a trusted identity manager (TIM) 110 (an identity authority) within a secure container 112. The example secure container 112 of FIG. 1 includes one or more secure applications 114 that, when executing, permit one or more transactions to occur in a trusted manner, as described in further detail below. The example secure container 112 provides an isolated execution environment (IEE), a root of trust to establish with a service provider, data sealing, random number generator(s) to generate strong cryptographic keys and nonces for signing attestations and encrypting data for sealed storage, establishment of trusted paths for one or more applications and/or authentication appliances 104a-n, and/or a realtime clock to minimize replay attacks involving stale messages. In some examples, the secure container 112 may be implemented in a manner consistent with International Publication Number WO 2010/057065 A2, entitled “Method and Apparatus to Provide Secure Application Execution,” filed on Nov. 14, 2009, which is hereby incorporated herein in its entirety. In other examples, the TIM 110 may be implemented on a smart card, such as a smart card containing tamper resistant data storage, authentication code and/or isolated processor(s).

The IEE generated by the example secure container 112 of FIG. 1 protects the TIM 110 and the secure applications 114 from system-software and hardware adversaries, such as attempts to intercept communication along a bus of the example client platform 102. The IEE generated by the example secure container 112 prevents hardware and/or software outside the secure container 112 from successfully reading, modifying and/or deleting the contents of the secure container 112. To allow the TIM 110 to perform attestation, the secure container 112 establishes the root of trust on the client platform 102, in which the root of trust may cryptographically measure the TIM 110 and/or the secure applications 114 on behalf of a requesting service provider 106. In some examples, the secure container 112 uses the measured root of trust to sign an attestation with a private key that never leaves the root of trust, and the service provider 106 may use a corresponding public key to verify the signature to determine whether the measurements and/or assertions are of expected value(s).

Data sealing facilitated by the example secure container 112 of FIG. 1 allows data to be protected when data is stored outside the secure container 112. The data sealing performed by the example secure container 112 may employ keys that are stored and used only within hardware security components, and/or data may be encrypted with measurements of a system state (e.g., a client platform 102 state) at a time of encryption. In some examples, decryption is performed only if the same system state measurements are collected at a time of decryption. If data that was previously sealed by the example secure container 112 were compromised, then decryption is thwarted unless the original platform key used during encryption is available.

In operation, the example TIM 110 of FIG. 1 enables an authorized user of the client platform 102 to obtain authorization to use the client platform 102 and one or more services thereof, authenticate the user at one or more service providers 106 without entering and/or disclosing common credentials, monitor user presence to prevent premature service provider timeouts and/or invoke a forced log-off between the client platform 102 and the service provider(s) 106 in the event the user leaves the vicinity of the client platform 102. The example TIM 110 allows, in part, the client platform 102 to establish a secure channel to one or more service providers 106, eliminate user disclosure of user credentials, and manage one or more sessions by presence monitoring. Presence monitoring may occur on a periodic basis, an aperiodic basis, a scheduled basis and/or a manual basis. As described in further detail below, presence monitoring may include facial recognition techniques that occur, for example, every ten seconds. In some examples, the monitoring of users may occur substantially continuously.

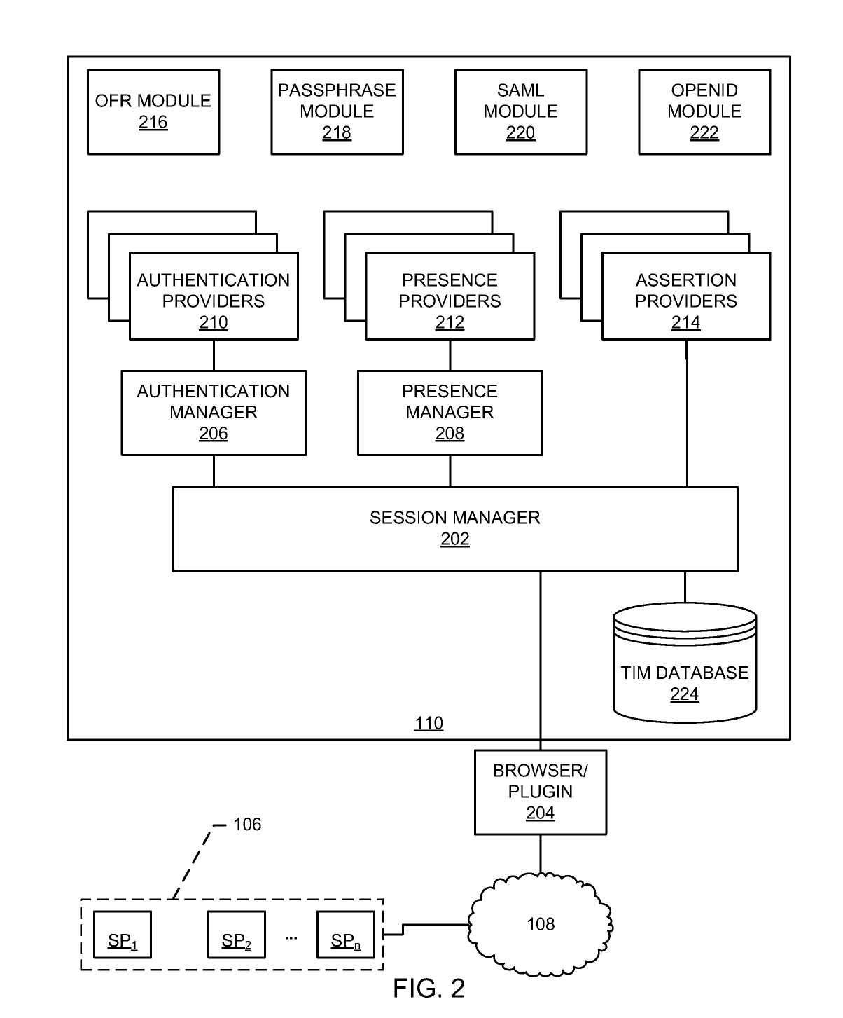

In the illustrated example of FIG. 2, the TIM 110 is shown in greater detail and includes a session manager 202 communicatively coupled to the service providers 106 via the network(s) 108 and a browser plugin 204. The example TIM 110 of FIG. 2 also includes an authentication manager 206, a presence manager 208, authentication providers 210, presence providers 212, and assertion providers 214. The example TIM 110 of FIG. 2 also includes an object facial recognition (OFR) module 216, a passphrase module 218, a security assertion markup language (SAML) module 220, an OpenID module 222, and a TIM database 224. As described in detail below, the example TIM 110 authorizes a user to use the TIM 110, invokes initial attestation procedure(s) with service providers 106 for newly connected users, invokes passive attestation procedure(s) with service providers 106 for on-going user session(s), establishes trusted relationships between the TIM 110 and the service providers 106, facilitates profile instructions unique to each user and/or service provider relationship, and monitors service provider sessions to ensure security.

Prior to a user interaction with the example TIM 110, the TIM 110 is unassigned, unauthorized and/or otherwise unassociated with the user of the example client platform 102. Prior to the example TIM 110 being able to issue assertions to one or more of the service providers 106 on behalf of a user, the example TIM 110 is associated with a user identity via the example authentication manager 206. User identities may be established in a number of ways including, but not limited to, obtaining third party issued credentials, generating private/public key pairs with a random number generator and time of day input(s), etc. For example, some jurisdictions include a department of motor vehicles (DMV) that issues an electronic driver's license. Such a license is an example of a secure credential to bind the example TIM 110 with the user. In the illustrated example, the credential may only be placed on the example TIM 110 by the third party issuer (e.g., the DMV), which can be verified via a public key issued by the third party. In an effort to maximize security, the third party issuer may require that certificates can only be applied to the TIM 110 if they are physically brought to the third party issuer (e.g., the DMV) for initial association. The third party certificate is associated with a combination of the TIM 110 and user identifier information and stored in the example TIM database 224.

Additionally, the example authentication manager 206 may require creation of TIM sign-on credentials, in which a single username and password combination is entered by the user during the time of association with the third party certificate at the physical location of issuing (e.g., at the DMV). The TIM sign-on credentials are stored in the example TIM database 224 which, because of the example secure container 112, is not accessible to external read and/or write attempts. In the illustrated example, while the TIM sign-on credentials are used to authorize the user with the example TIM 110, the TIM sign-on credentials are not used to authenticate with the service provider 106. The TIM sign-on credentials do not leave the example TIM 110, thereby minimizing the chance of detection by a hacker.

In some examples, the authentication manager 206 may invoke one or more of the authentication providers 210 to query system devices (e.g., a keyboard, a webcam, a smartcard reader, etc.) when creating the TIM sign-on credentials. Any number of TIM sign-on credential combinations may be established for authentication purposes. For example, service providers 106 related to relatively non-sensitive services (e.g., library web site) may permit full use of their website and/or portal after a minimal authentication procedure, such as a web-cam image match. In other examples, service providers 106 related to sensitive services (e.g., a bank web site) may only permit financial data viewing if the user authentication with the TIM 110 is limited to a web-cam image match, but will permit financial transactions when the authentication includes two or more differing and/or alternate authentication appliances, such as a combination of the web-cam image and a passcode.

After the example TIM 110 is associated with the user of the client platform 102, the example TIM 110 of FIG. 2 facilitates two stages of authenticating the user during session(s) with one or more service providers 106. A first stage of authentication includes initial authentication, in which the client platform 102 is locked, and a second stage of authentication includes passive re-authentication, in which the client platform 102 has been previously unlocked via authentication, but one or more indications of user presence are needed to maintain the unlocked state to prevent one or more other users from accessing the client platform 102 resources. A user profile, which may be stored in the example TIM database 224, may be employed to determine a level of security during initial authentication and/or passive re-authentication. In some examples, initial authentication requires a relatively strong level of security, in which a combination of credentials is required (e.g., web-cam image plus fingerprint scan plus passcode, or RFID badge detection plus web-cam image facial recognition). In other examples, passive re-authentication requires a lesser (relative to the authentication required for the initial authentication) degree of security, such as an occasional web-cam image capture of the user at the client platform 102. Passive re-authentication procedure(s) may occur on a periodic, aperiodic, scheduled and/or manual basis. However, the frequency and/or degree of authentication strength may be dictated by the user profile, service provider requirement(s), and/or combinations thereof.

After the example TIM 110 of FIG. 2 authenticates the user at the client platform 102, the example TIM 110 engages with a service provider 106 via one or more provisioning protocols during the first time of interaction with the user. In other words, each of the example TIM 110 and the service provider 106 must verify that the other party is trustworthy. In operation, the example session manager 202 determines whether the TIM 110 and the service provider 106 have a prior relationship with each other. If not, the example TIM 110 generates a shared name to be used when asserting user authentication to the example service provider 106. The example service provider 106 may also associate the shared name with an account that is related to the user. In some examples, the service provider 106 may perform an out-of-band evaluation of the example TIM 110 based on a cryptographic hash to determine whether the TIM 110 is legitimate. In other examples, the service provider 106 may verify the root of trust associated with the example secure container 112 to allow the service provider 106 to verify one or more attestations received from the example TIM 110.

In response to a user requesting resources from the service provider 106, the example TIM 110 of FIG. 2 sends an HTTP request including a flag indicative of the TIM 110 and/or the strength of authentication facilitated by the TIM 110 that allowed the user to gain access to the example client platform 102. When the TIM 110 receives a corresponding request from the service provider 106 for authentication, the TIM 110 verifies and/or otherwise determines whether to allow generation of a public/private key pair, based on, for example, one or more profile instructions stored in the example TIM database 224 in connection with the user. In some examples, the session manager 202 of the TIM 110 invokes one or more prompts on the client platform 102 requesting permission to release and/or otherwise send attestation(s) (e.g., a clickable dialog box). In some examples, the profiles permit automatic authorization to proceed with authentication procedures. Automatic authorization may be based on, for example, the service provider 106 with which the user is attempting to interact.

The example authentication manager 206 of the TIM 110 of FIG. 2 generates and/or otherwise provides the shared name to the service provider 106. The example shared name could be an alphanumeric string and/or the public key generated by the example authentication manager 206 for the service provider 106. In the event the example TIM 110 operates and/or otherwise interacts with other service providers 106, then the example authentication manager 206 may generate a unique private/public key pair for each corresponding service provider 106. To prove that the example TIM 110 is unmodified and running within an IEE, the example authentication manager 206 generates a self-attestation. As described above, the attestation employs the root of trust on the example secure container 112, which may be cryptographically measured and signed by the example TIM 110 using its private key, which does not leave the TIM 110 and/or the secure container 112. However, a corresponding public key is provided external to the TIM 110 so that the service provider 106 has the opportunity to verify anything signed by the TIM 110.

If the service provider 106 already has a pre-existing account for the user, then one or more out-of-band confirmation procedures may associate the user account with the shared name. Out-of-band confirmation may occur by way of, for example, a text message to a phone associated with the user that includes a code (e.g., randomly generated), an e-mail to the e-mail account associated with the user including the code, etc. On the other hand, if the user does not have a pre-existing account with the service provider 106, then one or more out-of-band account creation procedures may occur to establish one. In either case, the shared name and public key are associated with the user so that later attestations sent by the TIM 110 may be identified by a receiving service provider 106.

The example TIM 110 sends signed attestations to the service provider 106 to assert the user shared name and authentication information. Authentication information may include, but is not limited to, timestamp information, attestation expiration information, information related to TIM 110 authentication methods employed to provide the user with access to the client platform 102 (e.g., facial recognition, facial recognition plus fingerprint scan, facial recognition plus fingerprint scan plus passcode, etc.), etc. The shared name and authentication information generated by the example TIM 110 signed using the private key associated with the TIM/SP combination is sent to the service provider 106, and may be verified by the example service provider 106 using the public key. While the TIM 110 attests the methods it used to authenticate the user, the example TIM 110 of FIG. 2 does not send the user credentials that allowed initial access to the client platform 102. As such, by refraining from providing user credentials during the TIM attestation, storage of such credentials in remote providers is eliminated. This also prevents one or more adversaries from obtaining the user credentials and independently asserting the credentials without the ability to instrument the TIM 110 each time.

The example service providers 106 may each employ different protocols. To allow communication among different service providers 106 using different protocols, the example TIM 110 includes the OpenID module 222 and the SAML module 220. Generally speaking, OpenID is an open standard that defines a framework for user-centric and/or decentralized authentication, and SAML is an open standard for exchanging authentication and/or authorization data between one or more security domains. The use of open standards is beneficial for the TIM 110 and/or service providers 106 because it provides a publically available, pre-defined language of communication that can be used for each connection.

During an ongoing session between a user at the client platform 102 and the service provider 106, the example presence manager 208 determines whether the authenticated user is still present (e.g., in the vicinity of the client platform 102) by interfacing with the one or more presence providers 212. The example presence providers 212 of FIG. 2 query one or more of the authentication appliances 104a-n (e.g., via one or more modules, such as the example OFR module 216, the example passphrase module 218, etc.) for one or more authentication or re-authentication events. Authentication and/or re-authentication events may include messages from modules and/or authentication appliances 104a-n, such as a message indicative of a particular user being detected via a web-cam, a fingerprint scanner, and/or an indication that user presence is lost/absent.

One or more user policies are managed by the example session manager 202. For example, in response to receiving a message from the example authentication manager 206 and/or the example presence manager 208 that a user has been authenticated, the example session manager 202 queries the example TIM database 224 for instructions associated with the profile associated with the user. Resulting actions and/or permissions may be dictated by one or more profile instructions stored in the example TIM database 224, such as a degree of security required for particular service providers 106. For example, if a profile associated with a user specifies that automatic log-in to an e-mail service provider should occur, then the example session manager 202 will refrain from prompting the user with a permission dialog box prior to invoking the TIM 110 to send signed attestation(s) to the e-mail provider. In some examples, if the example presence manager 208 receives and/or otherwise generates a message indicative of a lost presence, the profile may dictate that the TIM 110 lock down to prevent someone else from using the client platform 102 during the absence of the user. Additionally, the profile may dictate that the TIM 110 forward a log-out message to one or more service providers 106 that were previously conducting an active session.

While an example manner of implementing the example CBA system 100 and the example TIM 110 have been illustrated in FIGS. 1 and 2, one or more of the elements, processes and/or devices illustrated in FIGS. 1 and 2 may be combined, divided, re-arranged, omitted, eliminated and/or implemented in any other way. Further, the example CBA system 100, the example client platform 102, the example authentication appliance pool 104, the example authentication appliances 104a-n, the example TIM 110, the example session manager 202, the example authentication manager 206, the example presence manager 208, the example authentication providers 210, the example presence providers 212, the example assertion providers 214, the example OFR module 216, the example passphrase module 218, the example SAML module 220, the example OpenID module 222 and/or the example TIM database 224 of FIGS. 1 and 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example CBA system 100, the example client platform 102, the example authentication appliance pool 104, the example authentication appliances 104a-n, the example TIM 110, the example session manager 202, the example authentication manager 206, the example presence manager 208, the example authentication providers 210, the example presence providers 212, the example assertion providers 214, the example OFR module 216, the example passphrase module 218, the example SAML module 220, the example OpenID module 222 and/or the example TIM database 224 of FIGS. 1 and 2 are hereby expressly defined to include a tangible computer readable medium such as a memory, DVD, CD, etc. storing the software and/or firmware. Further still, the example CBA system 100 and/or the example TIM 110 of FIGS. 1 and 2 may include one or more elements, processes and/or devices in addition to, or instead of, those illustrated in FIGS. 1 and 2, and/or may include more than one of any or all of the illustrated elements, processes and devices.

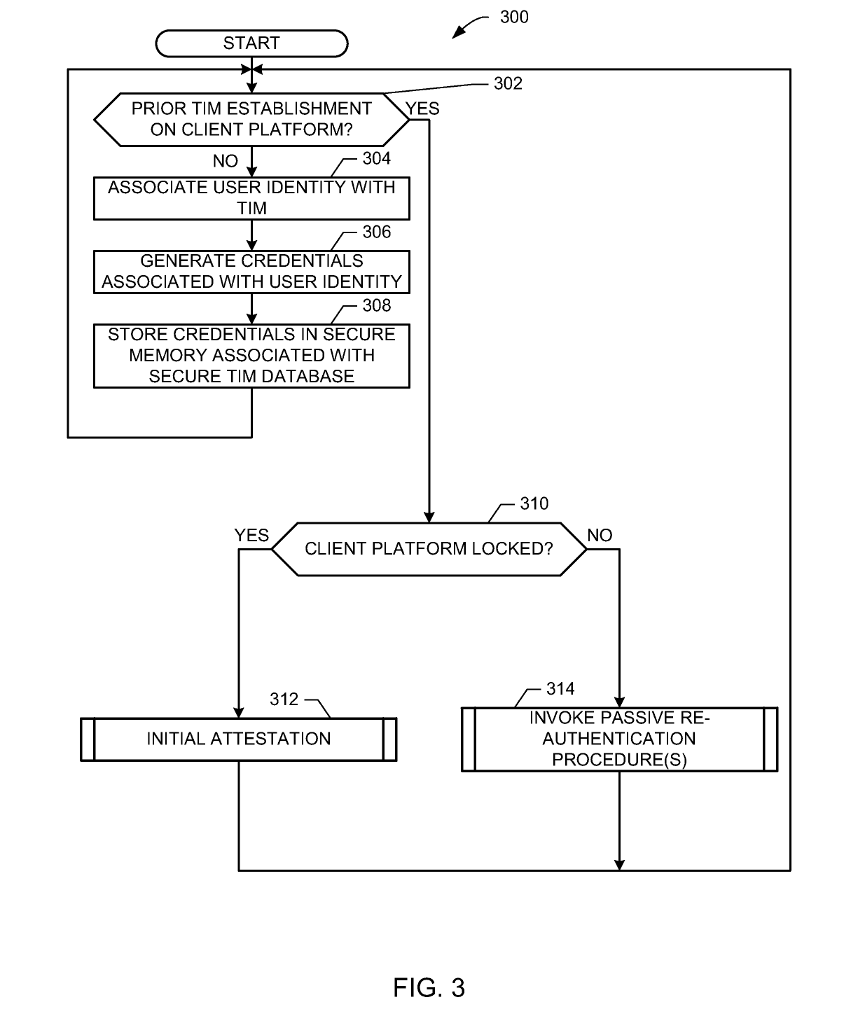

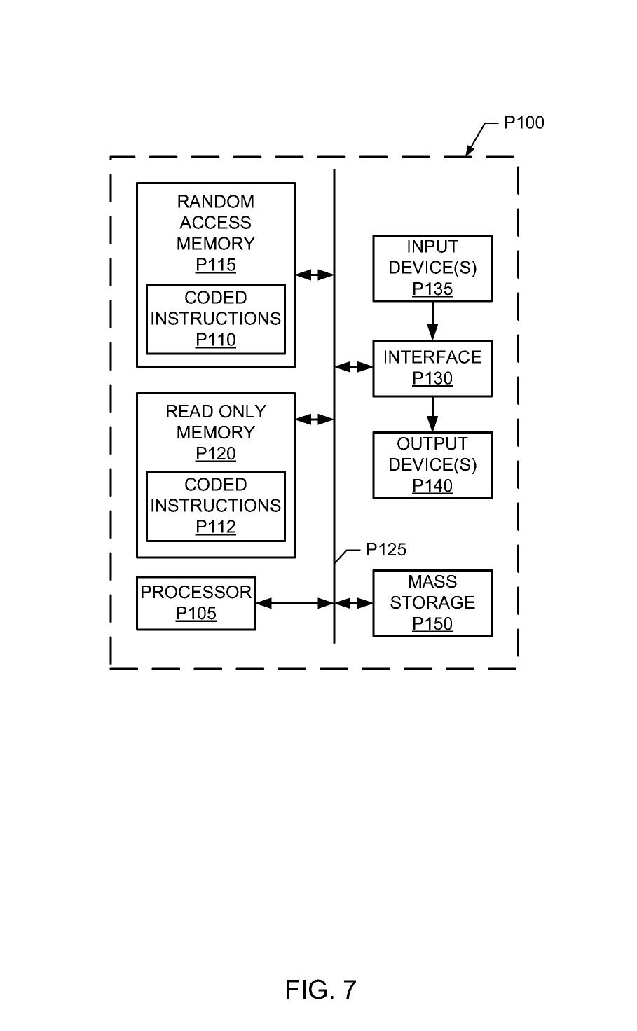

Flowcharts representative of example machine readable instructions for implementing the CBA system 100 of FIG. 1 and/or the example TIM 110 of FIGS. 1 and/or 2 are shown in FIGS. 3, 4A, 4B, 5 and/or 6. In these examples, the machine readable instructions comprise a program for execution by a processor such as the processor P105 shown in the example computer P100 discussed below in connection with FIG. 7. The program may be embodied in software stored on a tangible computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowcharts illustrated in FIGS. 3, 4A, 4B, 5 and/or 6, many other methods of implementing the example CBA system 100 and/or the example TIM 110 may alternatively be used. For example, the order of execution of the blocks may be changed, and/or some of the blocks described may be changed, eliminated, or combined.

As mentioned above, the example processes of FIGS. 3, 4A, 4B, 5 and/or 6 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage. Additionally or alternatively, the example processes of FIGS. 3, 4A, 4B, 5 and/or 6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium.

The program 300 of FIG. 3 begins at block 302 where the example session manager 202 determines whether the example TIM 110 has been established, assigned, authorized and/or otherwise associated with the client platform 102 and/or the user of the client platform 102. If not (block 302), then the example authentication manager 206 associates a user identity with the TIM 110 (block 304). As described above, the user identity may be associated with the TIM 110 by way of a third party issued credential(s) (e.g., a DMV issued electronic driver's license), or may be generated with the user in conjunction with a private/public key. The user may provide and/or select one or more credential(s) to associate with gaining access to the client platform 102 via the TIM 110 (block 306), and, in the illustrated example, such credentials do not leave the TIM 110 when stored within the example TIM database 224 (block 308).

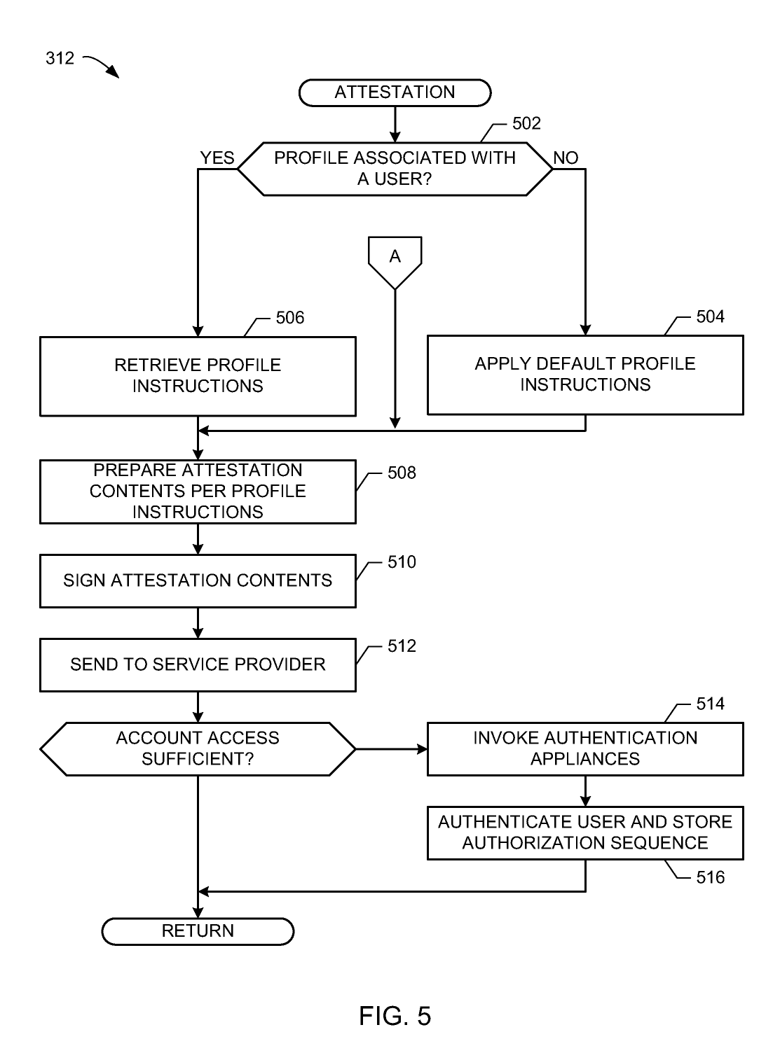

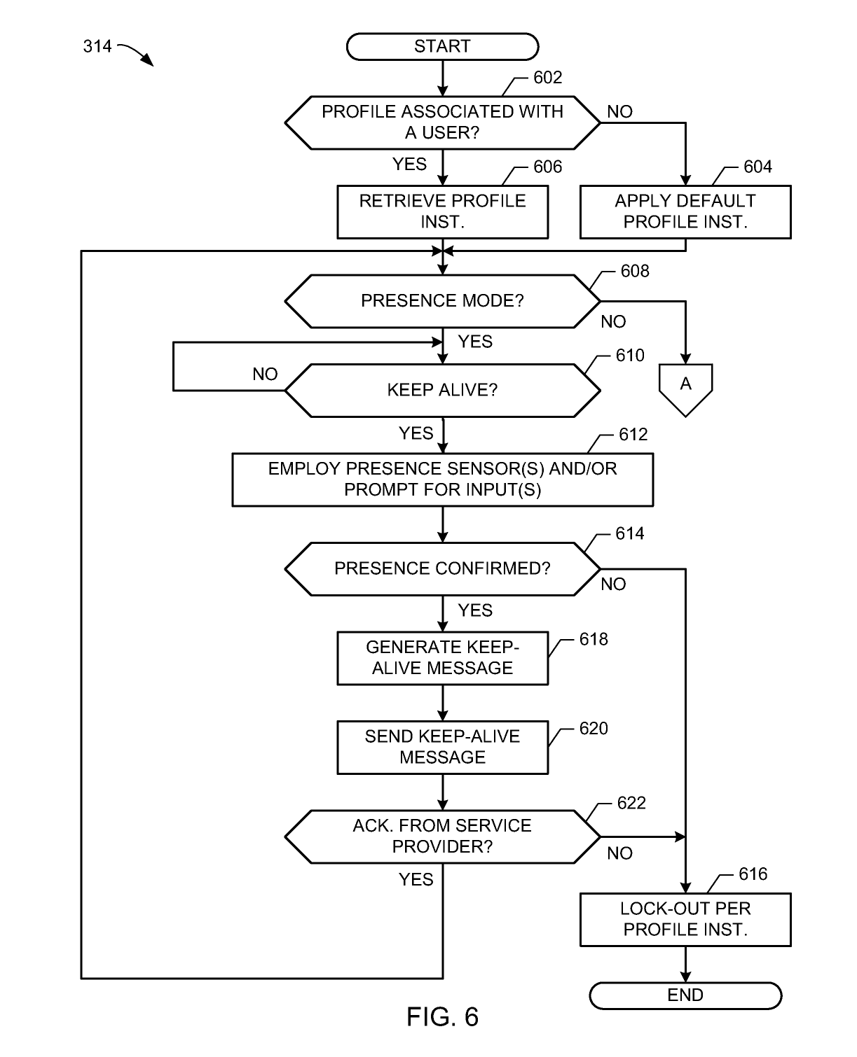

In the event that the example session manager 202 determines that the example TIM 110 has already been initialized with the client platform 102 (block 302), then the session manager 202 determines whether the client platform 102 is currently locked (block 310). A locked client platform 102 may occur when, for example, the client platform 102 is initially powered-up, if the user has logged-off an account, or if the user has stepped away from the platform 102. In some examples, a relatively higher degree of security authentication is required to access the client platform 102 if it was in a locked state, in which the degree of security for unlocking is dictated by one or more profile settings. If the client platform 102 is locked (block 310), then the example session manager 202 invokes the example authentication manager 206 to invoke initial attestation procedure(s) (block 312). Block 312 is described in further detail below in connection with FIG. 5. In the event that the example session manager 202 determines that the example client platform 102 is not currently locked (block 310), then the session manager 202 invokes the example presence manager 208 to invoke passive re-authentication procedure(s) (block 314). Block 314 is described in further detail below in connection with FIG. 6. The example program 300 of FIG. 3 then returns to block 302.

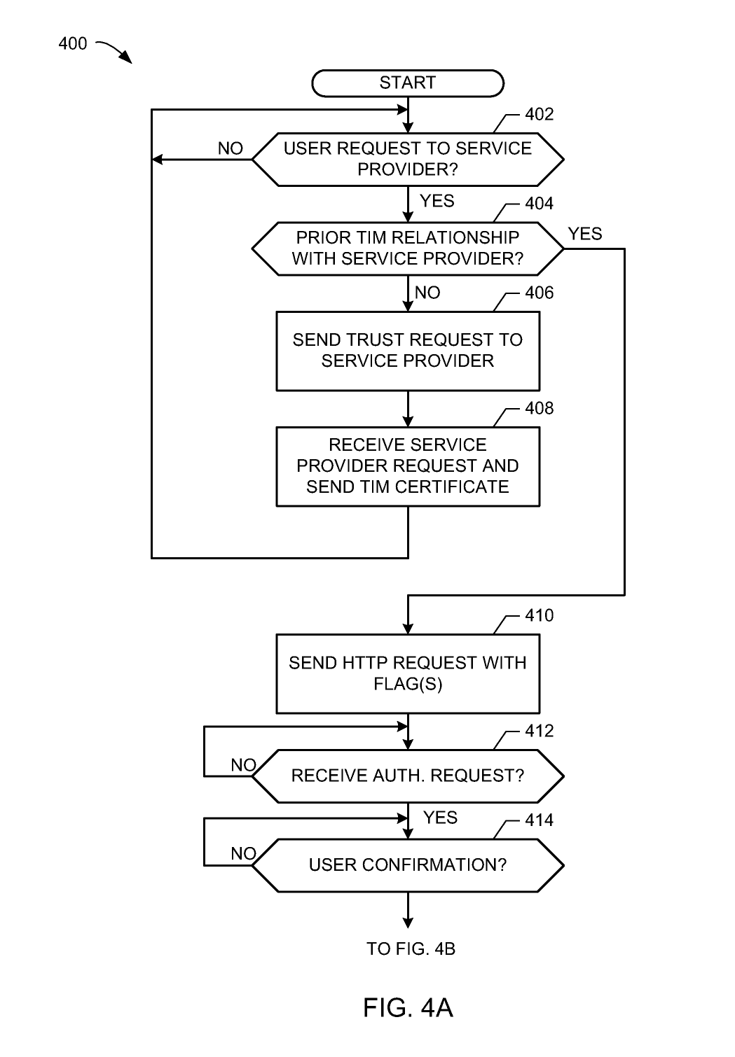

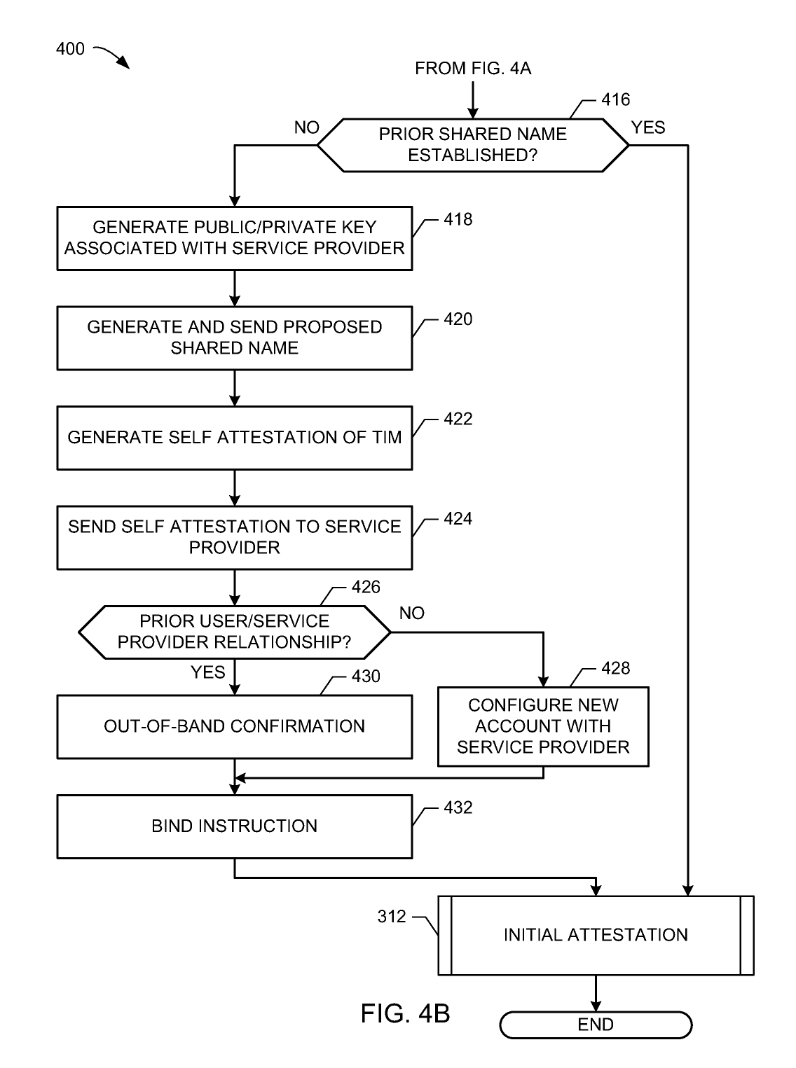

The program 400 of FIGS. 4A and 4B begins at block 402 where the example session manager 202 determines whether a request to communicate with a service provider 106 has occurred. If not (block 402), the example session manager 202 waits for such an occurrence. Otherwise the session manager 202 queries the example TIM database 224 to determine whether the TIM 110 has a prior and/or otherwise established relationship with the requested service provider 106 (block 404). If no prior relationship between the example TIM 110 and the service provider 106 has been established (block 404), the example authentication manager 206 sends a trust request initiation message to the service provider (block 406). In response to receiving acknowledgement from the service provider 106, the authentication manager 206 sends a TIM certificate to the service provider 106 (block 408). Control returns to block 402. The example service provider 106 may perform one or more out-of-band evaluation(s) of the TIM 110 to verify its authenticity and/or identity. For example, the service provider 106 may perform a cryptographic hash of the TIM 110 and/or may verify the root of trust associated with the example secure container 112.

Referring back to block 404, in the event the TIM 110 has a prior and/or otherwise established relationship with the requested service provider 106 (block 404), the example TIM 110 sends an HTTP request to the service provider 106 with one or more flags indicative of the fact that the TIM 110 was used to authenticate the user on the client platform 102 in a secure manner (block 410). The example authentication manager 206 waits for an authorization request from the service provider 106 (block 412) and, when received, determines whether the TIM 110 is authorized to proceed with creating and sending attestation information to the service provider 106 (block 414, see FIG. 4B). As described above, the user of the client platform 102 retains full control of whether information is to be sent from the client platform 102. Such control and/or instructions may be stored in the example TIM database 224, which may further include specific instructions based on the particular service provider 106.

In response to obtaining permission to proceed with sending attestation information from the example TIM 110 to the example service provider 106 (block 414), the example session manager 202 determines whether the service provider 106 has a prior established shared name associated with the user (block 416). If not, then the authentication manager 206 generates an authentication provider 210 profile to associate with a new public/private key pair associated with the service provider 106 (block 418). For each unique example service provider 106 with which the user interacts, the authentication manager 206 generates an additional and separate authentication provider 210 profile having an additional and separate unique public/private key pair and an associated shared name. The example authentication manager 206 generates and sends a proposed shared name for the user to the example service provider 106 (block 420).

To prove that the example TIM 110 is unmodified and executing within the example secure container 112, the attestation manager 206 generates a self-attestation of the TIM 110 (block 422) and sends the self-attestation to the service provider 106 (block 424). The self-attestation, as described above, may include cryptographic measurement of the TIM 110 and/or signing information with the TIM 110 private key and/or the secure container 112 private key. After the example TIM 110 is verified by the service provider 106, the example session manager 202 determines whether the user has an established account with the service provider 106 (block 426). If not, then the session manager 202 facilitates communication with the service provider 106 to configure a new account (e.g., a new bank account, a new library account, a new e-mail account, etc.) with the service provider 106 (block 428). If the user does have a pre-existing account and/or relationship with the service provider 106 (block 424), then one or more out-of-band confirmation messages may be exchanged via the session manager 202 to prove ownership with the prior account credentials of the user (block 430). However, to minimize and/or even eliminate future possibility of hackers jeopardizing the user's account, the example authentication manager 206 sends one or more bind instructions to the example service provider 106 containing the public key and the previously established shared name (block 432). The example bind instructions sent by the authentication manager 206 instruct the service provider to bind the account with the public key and the shared name and, in some examples, request that the service provider 106 delete old and/or previously used access credentials. In some examples, rather than delete the old and/or previously used access credentials, the authentication provider 210 profile may send a credential limitation instruction to the example service provider 106 so that the old and/or previously used access credentials only allow a limited amount and/or type of account access when used (e.g., allow account viewing, disallow account money transfer, etc.).

After the example TIM 110 is associated with the user, and the example TIM 110 is associated with a service provider 106, and the user is associated with the service provider 106 via the TIM 110 authentication, one or more attestations may occur between the user and the service provider(s) 106 (block 312). In the illustrated example of FIG. 5, the example session manager 202 determines whether a profile is associated with the user (block 502). If not (block 502), a default profile is generated for the user (block 504), which may reflect a conservative permission scope that requires express user interaction prior to sending one or more attestations to any service provider 106 with which the user interacts. On the other hand, if after querying the example TIM database 224, the example session manager 202 determines that the user has an associated profile (block 502), the session manager 202 retrieves the associated profile instructions (block 506).

Generally speaking, each of the users associated with a respective client platform 102 can set one or more policies/profiles with the TIM 110 to customize one or more security levels and/or user experiences. In some examples, a policy may allow automatic attestation of the user's authentication information to particular service providers 106 so that default behavior does not require express user confirmation. As described above, automatic attestation policies may be associated with one or more service providers 106 that have a minimal impact on the financial security of the user, such as service providers 106 associated with a library and/or a music streaming service. In other examples, a policy/profile may specify which shared names should be attested when interacting with specific service providers 106. For instance, if the user creates one or more different accounts for the same service provider 106, then the user may set different policies regarding which shared names should be manually attested, automatically attested, a degree of attestation security (e.g., facial recognition, facial recognition plus passcode, etc.). In still other examples, a profile may specify a duration of user absence before passive re-authentication fails. Additionally, in the event re-authentication fails due to, for example, a user walking away from their client platform 102, the profile may instruct the service provider to shut down the account and shut down the client platform 102.

Based on the profile instructions associated with the user (block 506) or default profile instructions (block 504), the example authentication provider(s) 210 is invoked by the authentication manager 206 to prepare attestation contents (block 508). The example authentication provider(s) 210 query one or more authentication appliances 104a-n for authentication events from the user. A single authentication appliance and/or any combination of authentication appliances may be used when preparing the attestation information to be sent to the service provider 106. One or more invoked authentication appliances results in an authorization sequence performed at the example client platform 102 to gain access and/or functionality of the example client platform 102. An example authentication provider 210 may support object facial recognition (OFR) via the example OFR module 216. The example OFR module 216 receives video from a webcam and uses one or more facial recognition algorithms to identify faces (e.g., human faces). In the event the OFR module 216 identifies a face, it invokes the corresponding authentication provider 210 to query the TIM database 224 for a match. Based on the query results, the example OFR module 216 may return an identification confirmation message or an identification unknown message. In some examples, the authentication provider(s) 210 may invoke the example passphrase module 218 to prompt the user to enter one or more passphrases. The example passphrase module 218 sends the received passphrase to the example corresponding authentication provider 210 and compares it to an authorized passphrase(s) stored in the example TIM database 224. In the event the passphrase is correct and/or the passphrase is associated with a previously identified face, the authentication manager 206 unlocks the client platform 102.

As described above, one or more authentication types results in an authorization sequence that may be forwarded to one or more example service providers. In some examples, service provider 106 access depends on a degree of security used at the client platform 102 when authorizing user access thereof. For example, an authorization sequence that includes a single authentication appliance (e.g., a webcam) may only afford the user limited functionality when interacting with the service provider 106 (e.g., account balance review allowed, account balance transfer restricted, etc.). On the other hand, an authorization sequence that includes multiple authentication appliances reflects a higher degree of user authentication of the client platform 102, which may result in greater service provider 106 privileges.

The manner in which the user was authenticated to the TIM 110 is packaged into the attestation message (e.g., whether facial recognition was used, whether a combination of authentication appliances were used, etc.) (block 508) and is signed by the TIM 110 private key unique to that service provider 106 (block 510). The signed attestation contents are sent to the service provider 106 to authenticate the user with the example service provider 106 (block 512), which does not include easily interceptable and/or insecure cleartext username/password combinations.

The example session manager 202 queries the TIM database 224 to determine whether a level of account access with the service provider 106 is sufficient (block 514). For example, one or more profiles associated with the user, the client platform 102 and/or the TIM 110 may expect particular service providers to enable one or more degrees of account access, such as view-only access versus view and transfer access (e.g., in a banking scenario). In the event that one or more service providers 106 require a higher degree of client authentication than was initially performed, then account access may be limited. For instance, access to the client platform 102 may have been initially and/or otherwise previously authenticated by way of only facial recognition, while the service provider of interest may require a combination of authentication appliances before a greater degree of account privileges is permitted. The example authentication manager 206 of the illustrated example invokes one or more additional authentication appliances 104 (block 516), authenticates the user via the one or more authentication appliances 106 and stores the new authorization sequence information in the example TIM database 224 (block 518).

In the illustrated example of FIG. 6, a program 314 to monitor for presence activity begins at block 602 where the session manager 202 determines whether the user has an associated profile. If not (block 602), then a default profile may be employed (block 604). Otherwise the example session manager 202 retrieves profile information from the example TIM database 224 (block 606). The example session manager 202 determines whether the client platform 102 is in a presence mode (block 608). If not, the client platform 102 is assumed to be currently locked-down (block 608). As described above, the client platform 102 may be locked-down after it initially powers up from a prior powered-down state, or the client platform 102 may be locked-down in response to the user walking away. On the other hand, if the user is currently involved in one or more session(s) with one or more service providers 106, the example TIM 110 operates in a presence mode that verifies the user's presence on a scheduled, periodic, aperiodic and/or manual basis.

In the event the example client platform 102 is not in a presence mode (block 608) (e.g., in a locked-down state), control advances to block 508 of FIG. 5 to prepare attestation contents and unlock the client platform 102. On the other hand, in the event that the example client platform 102 is in a presence mode (block 608), the example session manager 202 determines whether a keep alive message should be sent from the TIM 110 to the service provider 106 (block 610). Keep alive messages may be sent on a periodic, aperiodic, scheduled and/or manual basis in an effort to address denial of service (DoS) attacks against the example TIM 110. For example, if a DoS attack prevents the TIM 110 from sending the keep alive message, a receiving service provider 106 may terminate the one or more session(s) in an abundance of caution.

If the session manager 202 determines that the keep alive message does not need to be sent (e.g., according to a timer threshold value) (block 610), the example program 600 waits. Otherwise, the example presence manager 208 invokes one or more presence providers 212 to employ corresponding authentication appliances 104a-n and, in some examples, prompts the user for additional input(s) (block 612) to prepare the keep alive message. The example presence manager 208 determines whether the authenticated user is still present by interfacing with one or more presence providers 212 (block 614), which may query one or more system devices for passive re-authentication events. In some examples, the OFR module 216 is invoked to capture an image and compare it to one or more known image profiles stored in the example TIM database 224. The one or more known images may include varying profile angles for each authorized user of the client platform 102, such as a forward-facing image, a side-facing image and/or one or more varying intermediate viewing angles therebetween, for example.

If the presence manager 208 determines that presence is not confirmed (block 614), the example session manager 202 invokes the authentication manager 206 to generate a lock-out procedure based on the profile instructions retrieved from the example TIM database 224 (block 616). The example presence manager 208 may generate an absence message in response to an absence of one or more indications of presence from the authentication appliance(s) during a threshold period of time. The absence message may indicate that one or more authentication appliances 104 are dormant. The lock-out procedure may include a lock-out of the client platform 102 or may include a lock-out of both the client platform 102 and a lock-out request message directed to one or more service providers 106 that were previously involved in an active session(s). However, if the presence is confirmed within a threshold period of time (block 614), the example presence manager 208 generates a keep alive and/or presence message (block 618) and sends it to the service provider(s) 106 (block 620). After the keep alive message is sent (block 620), the example presence manager 208 may monitor for one or more acknowledgement message(s) from respective service providers 106 as confirmation that the keep alive message was successfully received (block 622). If no acknowledgement is received (e.g., within a threshold time period), the service provider 106 may assumed to be under a DoS attack, and the example presence manager 208 may lock-out the client (block 616). On the other hand, after the acknowledgement of successful receipt is received (block 622), control advances to block 608.

FIG. 7 is a block diagram of an example processing platform P100 capable of executing the instructions of FIGS. 3, 4A, 4B, 5 and 6 to implement the example CBA system 100 of FIG. 1 and/or the example TIM 110 of FIGS. 1 and/or 2. The processor platform P100 can be, for example, a server, a personal computer, a tablet, a mobile phone, or any other type of computing device.

The processor platform P100 of the instant example includes a processor P105. For example, the processor P105 can be implemented by one or more Intel® microprocessors. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller.

The processor platform P100 also includes an interface circuit P130. The interface circuit P130 may be implemented by any type of past, present or future interface standard, such as an Ethernet interface, a universal serial bus (USB), and/or a PCI express interface.

One or more input devices P135 are connected to the interface circuit P130. The input device(s) P135 permit a user to enter data and commands into the processor P105. The input device(s) can be implemented by, for example, a keyboard, a mouse, a touchscreen, a track-pad, a trackball, isopoint, a camera, a fingerprint scanner, biometric sensor(s) and/or a voice recognition system.

One or more output devices P140 are also connected to the interface circuit P130. The output devices P140 can be implemented, for example, by display devices (e.g., a liquid crystal display, and/or a cathode ray tube display (CRT)). The interface circuit P130, thus, typically includes a graphics driver card.

The interface circuit P130 also includes a communication device, such as a modem or network interface card to facilitate exchange of data with external computers via a network (e.g., an Ethernet connection, a digital subscriber line (DSL), a telephone line, coaxial cable, a cellular telephone system, etc.).

The processor platform P100 also includes one or more mass storage devices P150 for storing software and data. Examples of such mass storage devices P150 include floppy disk drives, hard drive disks, compact disk drives and digital versatile disk (DVD) drives.

The coded instructions of FIGS. 3, 4A, 4B, 5 and 6 may be stored in the mass storage device P150, in the volatile memory P110, in the non-volatile memory P112, and/or on a removable storage medium such as a CD or DVD.

From the foregoing, it will be appreciated that disclosed example methods, apparatus, systems and/or articles of manufacture allow users of client platforms to establish a secure beachhead that reduces reliance upon service provider provisioned security measures, and allows service providers to trust requests arriving from network communications. Additionally, the example methods, apparatus, systems and/or articles of manufacture disclosed herein remove redundant user-selected username/password combinations from being proliferated among the user's preferred service providers. In the event one of the user's service providers is attacked, hacked and/or otherwise compromised, the example methods, apparatus, systems and/or articles of manufacture disclosed herein do not rely on stored username/password combinations at the service provider for authentication purposes, thereby limiting user risk with other service provider and/or account security.

Methods, system, apparatus and articles of manufacture are disclosed to facilitate client-based authentication. Some disclosed example methods include associating an identity authority with a client platform in an isolated execution environment, associating a user identity with the identity authority, generating a first key pair associated with a first service provider, generating an attestation based on a first authorization sequence of the client platform, and signing the attestation with a portion of the key pair and sending the signed attestation to the first service provider to authorize communication between the client platform and the first service provider. Additionally, the example methods include identifying a first access privilege associated with the first service provider in response to sending the signed attestation. In some examples, the method includes invoking at least one authentication appliance to generate a second authorization sequence, and wherein the second authorization sequence results in a second access privilege associated with the first service provider. In other examples, the user identity comprises a third party certificate, while in still other examples the method includes generating a second key pair in response to receiving a request to communicate with a second service provider. Other methods include sending the signed attestation based on a profile, wherein the profile authorizes automatically sending the signed attestation for the first service provider and invokes a second authorization sequence for a second service provider.

Example apparatus to facilitate client-based authentication include an identity manager to associate a user with a client platform, an authentication provider to generate a first key pair associated with a first service provider, and an authentication manager to generate an attestation based on a first authorization sequence of the client platform, and to sign the attestation with a portion of the key pair to authorize communication between the client platform and the first service provider. Additional example apparatus include a presence provider to invoke an authentication appliance associated with the client platform, and a presence manager to generate a presence message in response to an indication of presence from the authentication appliance within a threshold period of time. Additionally, the example apparatus include a presence manager to generate an absence message in response to an indication of an absence of presence from the authentication appliance for a threshold period of time, and a session manager to provide a log-off message to the first service provider when the authentication appliance is dormant for a threshold period of time. In other examples, the apparatus includes a presence manager to monitor the user on at least one of a periodic, an aperiodic, a scheduled, or a manual basis, wherein the periodic monitoring is substantially continuous.

Some disclosed example articles of manufacture storing machine readable instructions are included that, when executed, cause a machine to associate an identity authority with a client platform in an isolated execution environment, associate a user identity with the identity authority, generate a first key pair associated with a first service provider, generate an attestation based on a first authorization sequence of the client platform, and sign the attestation with a portion of the key pair and sending the signed attestation to the first service provider to authorize communication between the client platform and the first service provider. Other example articles of manufacture cause the machine to identify a first access privilege associated with the first service provider in response to sending the signed attestation. Still other example articles of manufacture cause the machine to invoke at least one authentication appliance to generate a second authorization sequence. In other examples, articles of manufacture cause the machine to generate a second key pair in response to receiving a request to communicate with a second service provider. Additionally, example articles of manufacture cause the machine to send the signed attestation based on a profile. Other example articles of manufacture cause the machine to authorize automatically sending the signed attestation for the first service provider and invoke a second authorization sequence for a second service provider, and still further example articles of manufacture cause the machine to request a dialog permission input based on the profile.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to authorize client platform communication, comprising:
associating an identity authority with a client platform in an isolated execution environment;
associating a user identity with the identity authority;
generating a first key pair associated with a first service provider;
generating an attestation based on a first authorization sequence of the client platform; and
signing the attestation with a portion of the key pair and sending the signed attestation to the first service provider to authorize communication between the client platform and the first service provider.

2. A method as described in claim 1, further comprising identifying a first access privilege associated with the first service provider in response to sending the signed attestation.

3. A method as described in claim 2, further comprising invoking at least one authentication appliance to generate a second authorization sequence.

4. A method as described in claim 3, wherein the second authorization sequence results in a second access privilege associated with the first service provider.

5. A method as described in claim 1, wherein the user identity comprises a third party certificate.

6. A method as described in claim 1, further comprising generating a second key pair in response to receiving a request to communicate with a second service provider.

7. A method as described in claim 1, further comprising sending the signed attestation based on a profile.

8. A method as described in claim 7, wherein the profile authorizes automatically sending the signed attestation for the first service provider and invokes a second authorization sequence for a second service provider.

9. An apparatus to authorize client platform communication, comprising:
an identity manager to associate a user with a client platform;
an authentication provider to generate a first key pair associated with a first service provider; and
an authentication manager to generate an attestation based on a first authorization sequence of the client platform, and to sign the attestation with a portion of the key pair to authorize communication between the client platform and the first service provider.

10. An apparatus as described in claim 9, further comprising a presence provider to invoke an authentication appliance associated with the client platform.

11. An apparatus as described in claim 10, further comprising a presence manager to generate a presence message in response to an indication of presence from the authentication appliance within a threshold period of time.

12. An apparatus as described in claim 10, further comprising a presence manager to generate an absence message in response to an indication of an absence of presence from the authentication appliance for a threshold period of time.

13. An apparatus as described in claim 10, further comprising a session manager to provide a log-off message to the first service provider when the authentication appliance is dormant for a threshold period of time.

14. An apparatus as described in claim 10, further comprising a presence manager to monitor the user on at least one of a periodic, an aperiodic, a scheduled, or a manual basis.

15. An apparatus as described in claim 14, wherein the periodic monitoring is substantially continuous.

16. A tangible machine accessible medium having instructions stored thereon that, when executed, cause a machine to, at least:
associate an identity authority with a client platform in an isolated execution environment;
associate a user identity with the identity authority;
generate a first key pair associated with a first service provider;
generate an attestation based on a first authorization sequence of the client platform; and
sign the attestation with a portion of the key pair and send the signed attestation to the first service provider to authorize communication between the client platform and the first service provider.

17. A tangible machine accessible medium as described in claim 16 having instructions stored thereon that, when executed, cause a machine to identify a first access privilege associated with the first service provider in response to sending the signed attestation.

18. A tangible machine accessible medium as described in claim 17 having instructions stored thereon that, when executed, cause a machine to invoke at least one authentication appliance to generate a second authorization sequence.

19. A tangible machine accessible medium as described in claim 16 having instructions stored thereon that, when executed, cause a machine to generate a second key pair in response to receiving a request to communicate with a second service provider.

20. A tangible machine accessible medium as described in claim 16 having instructions stored thereon that, when executed, cause a machine to send the signed attestation based on a profile.

21. A tangible machine accessible medium as described in claim 20 having instructions stored thereon that, when executed, cause a machine to authorize automatically sending the signed attestation for the first service provider and invoke a second authorization sequence for a second service provider.

22. A tangible machine accessible medium as described in claim 20 having instructions stored thereon that, when executed, cause a machine to request a dialog permission input based on the profile.
